(19) United States
(12) Patent Application Publication
(10) Pub. No.: US 2025/0233198 A1
(43) Pub. Date: Jul. 17, 2025

(54) SOLID ELECTROLYTE AND ALL-SOLID-STATE BATTERY COMPRISING THE SAME

(71) Applicant: SAMSUNG ELECTRO-MECHANICS CO., LTD., Suwon-si (KR)

(72) Inventors: Dongwon Kim, Suwon-si (KR); Taehoon Kim, Suwon-si (KR); Kwangjik Lee, Suwon-si (KR); Han Kim, Suwon-si (KR)

(73) Assignee: SAMSUNG ELECTRO-MECHANICS CO., LTD., Suwon-si (KR)

(21) Appl. No.: 19/011,089

(22) Filed: Jan. 6, 2025

Related U.S. Application Data
(63) Continuation-in-part of application No. PCT/KR2024/013927, filed on Sep. 12, 2024.

(30) Foreign Application Priority Data
Jan. 11, 2024 (KR) 10-2024-0004788

(51) Int. Cl. H01M 10/056; H01M 10/0525

(52) U.S. Cl. CPC H01M 10/056; H01M 10/0525; H01M 2300/0068; H01M 2300/0091

(57) ABSTRACT

The present disclosure relates to a solid electrolyte that is a composite including a first glass ceramic compound and a second glass ceramic compound. The first glass ceramic compound includes a Na super-ionic conductor (NASICON) structure compound or a garnet structure compound. The second glass ceramic compound includes Li, B, O, and halogen elements, and at least one of Ga, Zn, Mg, Al, Ge, Si, Ti, P, and Bi.

### Cross-Reference to Replated Application

This application is a Bypass Continuation-in-Part application of PCT/KR2024/013927 filed on Sep. 12, 2024, which claims priority to and the benefit of Korean Patent Application No. 10-2024-0004788 filed in the Korean Intellectual Property Office on Jan. 11, 2024, the entire contents of which are incorporated herein by reference.

### TECHNICAL FIELD

The present disclosure relates to a solid electrolyte and an all-solid-state battery comprising the same.

### BACKGROUND ART

Currently commercialized lithium secondary batteries are manufactured based on liquid electrolyte, and in this case, there is a high risk of explosion and fire, especially when the battery is damaged due to external impact.

Accordingly, all-solid-state batteries based on solid electrolytes are being actively developed to improve battery stability, and are attracting attention as next-generation batteries. Particularly, all-solid-state batteries have great potential in the electric vehicle (EV) and energy storage system (ESS) markets, where battery safety can be directly linked to property and human damage, and related research is actively being conducted. In addition, in addition to medium and large-sized batteries for EV and ESS, the development of small-sized all-solid-state batteries is also being conducted, and mass production is expected to begin in the near future.

Due to the characteristic of all-solid-state batteries without a separator, the development of a solid electrolyte with high ionic conductivity and low electronic conductivity is very important. Additionally, in order to increase the efficiency of the all-solid-state battery manufacturing process, drying, plasticizing, and firing at low temperatures must be possible. Among the solid electrolyte candidates currently in the spotlight, lithium lanthanum zirconium oxide with a garnet structure has shown high ionic conductivity and can be utilized as an electrolyte for all-solid-state batteries. However, due to the high firing temperature of over 1000° C., the improvement in density between the solid electrolyte layer and the electrode active material particles is extremely limited.

### DISCLOSURE OF INVENTION

### Technical Problem

The present disclosure attempts to provide a solid electrolyte with excellent ionic conductivity and low firing temperature, and an all-solid-state battery including the same.

### Solution to Problem

An embodiment of the present disclosure provides a solid electrolyte that is a composite including a first glass ceramic compound and a second glass ceramic compound.

The first glass ceramic compound may include a Na super-ionic conductor (NASICON) structure compound or a garnet structure compound.

The Na super-ionic conductor structure compound may be represented by the following Chemical Formula 1:

Liₐ₁M1_{b1}Al_{c1}(PO₄)_{d1} [Chemical Formula 1]
in Chemical Formula 1, M1 is a doping element and is Ti, Ga, or a combination thereof, 1≤a1≤1.5, 0.1≤b1≤2.5, 0≤c1≤1.5, and 3.5≤d1≤4.5.

The garnet structure compound may be represented by the following Chemical Formula 2:

Liₐ₂La_{b2}Zr_{c2}M2_{d2}Oₑ₂ [Chemical Formula 2]
in Chemical Formula 2, M2 is a doping element and is Ga, Al, Rb, Ti or a combination thereof, 5.5≤a2≤7.5, 2.5≤b2≤3.5, 1.5≤c2≤2.5, 0≤d2≤1, and 11.5≤e2≤12.5.

The second glass ceramic compound includes Li, B, O, and halogen elements, and may further include at least one of Ga, Zn, Mg, Al, Ge, Si, Ti, P, and Bi.

The second glass ceramic compound may be represented by the following Chemical Formula 3.

Liₐ₃B_{b3}O_{c3}D_{d3}M3ₑ₃ [Chemical Formula 3]
in Chemical Formula 3, D is a halogen element and is F, Cl, Br, I or a combination thereof, M3 is Ga, Zn, Mg, Al, Ge, Si, Ti, P, Bi or a combination thereof, 3≤a3≤4, 3.5≤b3≤5.5, 11.5≤c3≤12.5, O≤d3≤1, and 1.5≤e3≤3.5.

The first glass ceramic compound may occupy 51% by volume or more based on the total volume of the solid electrolyte.

The second glass ceramic compound may occupy 49% by volume or less based on the total volume of the solid electrolyte.

The first glass ceramic compound may have greater lithium ion conductivity than the second glass ceramic compound.

The second glass ceramic compound may have lower electronic conductivity than the first glass ceramic compound.

The first glass ceramic compound may have a lithium ion conductivity of 1.0×10⁻⁵ S/cm or more at 25° C.

The second glass ceramic compound may have a lithium ion conductivity of 1.0×10⁻⁵ S/cm or less at 25° C.

The first glass ceramic compound may have an electronic conductivity of 2.0×10⁻¹⁰ S/cm or more at 25° C.

The second glass ceramic compound may have an electronic conductivity of 2.0×10⁻¹⁰ S/cm or less at 25° C.

The first glass ceramic compound and the second glass ceramic compound may include an amorphous phase and one or more crystalline phases.

The first glass ceramic compound may occupy a greater volume percentage than the second glass ceramic compound based on the total volume of the solid electrolyte.

Another embodiment of the present disclosure provides an all-solid-state battery, including a positive electrode layer, a negative electrode layer, and a solid electrolyte layer positioned between the positive electrode layer and the negative electrode layer, wherein the solid electrolyte layer includes the solid electrolyte described above.

The positive electrode layer may include a current collector and a positive electrode active material layer positioned on the current collector, and the negative electrode layer may include a current collector and a negative electrode active material layer positioned on the current collector, and the positive electrode active material layer or the negative electrode active material layer may include the solid electrolyte described above.

### Advantageous Effects of Invention

The solid electrolyte according to an embodiment of the present disclosure is a composite of two different glass ceramic compounds, thereby having excellent ionic conductivity and lowering the sintering temperature when manufacturing an all-solid-state battery. Accordingly, the all-solid-state battery manufacturing process cost may be reduced, and the density between the solid electrolyte layer and the electrode active material particles may be improved.

### BRIEF DESCRIPTION OF DRAWINGS

FIG. 1 is an SEM image of a solid electrolyte prepared according to Example 1.

### MODE FOR THE INVENTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. The accompanying drawings are intended only to facilitate an understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure. In the accompanying drawings, some constituent elements are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Throughout the specification, the “stacking direction” refers to the direction in which the constituent elements are sequentially stacked, and may also be the “thickness direction” perpendicular to the wide surface (main surface) of the constituent elements on the sheet, which corresponds to the T-axis direction. Also, the “side” refers to the direction extending parallel to the wide surface (main surface) from the edge of the constituent element on the sheet, which may be a “plane direction”, and corresponds to the L-axis direction in the drawing.

In this specification, “solid electrolyte” refers to a material capable of conducting electric current through the movement of lithium ions in a solid state. As used herein, “ionic conductivity” is a measure of a tendency of material to conduct ions, which theoretically increases in proportion to the concentration of ions, the amount of charge, and the mobility of the charge.

### 1. Solid Electrolyte

The solid electrolyte according to an embodiment of the present disclosure is a composite including a first glass ceramic compound and a second glass ceramic compound.

As used herein, “glass ceramic” refers to a material that contains an amorphous phase and one or more crystalline phases by heating and treating amorphous glass to precipitate a crystalline phase (i.e., partial crystallization), and has both amorphous and crystalline characteristics.

In addition, as used herein, “amorphous glass” refers to a material that does not show diffraction peaks indicating crystals during X-ray diffraction analysis, that is, has no crystalline phase and is highly transparent.

At this time, the first glass ceramic compound may be a Na super-ionic conductor (NASICON) structure compound or a garnet structure compound.

More specifically, the NASICON structure compound may be represented by the following Chemical Formula 1:

Liₐ₁M1_{b1}Al_{c1}(PO₄)_{d1} [Chemical Formula 1]
in Chemical Formula 1, M1 is a doping element and is Ti, Ga, or a combination thereof, and 1≤a1≤1.5, 0.1≤b1≤2.5, 0≤c1≤1.5, 3.5≤d1≤4.5.

More specifically, the garnet structure compound may be represented by the following Chemical Formula 2:

Liₐ₂La_{b2}Zr_{c2}M2_{d2}Oₑ₂ [Chemical Formula 2]

in Chemical Formula 2, M2 is a doping element and is Ga, Al, Rb, Ti or a combination thereof, 5.5≤a2≤7.5, 2.5≤b2≤3.5, 1.5≤c2≤2.5, 0≤d2≤1, 11.5≤e2≤12.5.

Additionally, the second glass ceramic compound includes Li, B, O, and halogen elements, and may further include at least one of Ga, Zn, Mg, Al, Ge, Si, Ti, P, and Bi.

More specifically, the second glass ceramic compound may be represented by the following Chemical Formula 3:

Liₐ₃B_{b3}O_{c3}D_{d3}M3ₑ₃ [Chemical Formula 3]

in Formula 3, D is a halogen element and is F, Cl, Br, I or a combination thereof, M3 is Ga, Zn, Mg, Al, Ge, Si, Ti, P, Bi or a combination thereof, 3≤a3≤4, 3.5≤b3≤5.5, 11.5≤c3≤12.5, O≤d3≤1, 1.5≤e3≤3.5.

In general, when amorphous glass undergoes crystallization and becomes glass ceramic, its ionic conductivity often decreases.

On the other hand, the first glass ceramic compound and the second glass ceramic compound having the above composition may have high ionic conductivity because the glass ceramic behaves like a kind of oxide crystal. In addition, the first glass ceramic compound and the second glass ceramic compound of the above composition behave in an amorphous state before reaching the crystallization temperature during the sintering process, which facilitates junction with other compounds, resulting in good sintering behavior, and when sintering is completed, a solid electrolyte in the form of a composite having a high ionic conductivity may be obtained.

At this time, the first glass ceramic compound may have greater lithium ion conductivity than the second glass ceramic compound. Additionally, the first glass ceramic compound has a higher crystallization temperature than the second glass ceramic compound, and thus the sintering temperature may be higher. In other words, according to the present disclosure, the solid electrolyte is a composite of the first glass ceramic compound with high ion conductivity but high sintering temperature, and the second glass ceramic compound with relatively low ion conductivity but low sintering temperature, so that the advantages of the first glass ceramic compound and the second glass ceramic compound may be evenly implemented.

That is, the solid electrolyte according to the present disclosure is a composite of the first glass ceramic compound and the second glass ceramic compound, and thus has excellent ionic conductivity and may lower the sintering temperature when manufacturing an all-solid-state battery. Accordingly, the all-solid-state battery manufacturing process cost may be reduced, and the density between the solid electrolyte layer and the electrode active material particles may be improved.

At this time, the first glass ceramic compound may occupy 51% by volume or more, more specifically, 51 to 99% by volume or 80 to 97% by volume based on the total volume of the solid electrolyte. Additionally, the second glass ceramic compound may occupy 49% by volume or less, more specifically, 1 to 49% by volume or 3 to 20% by volume based on the total volume of the solid electrolyte. If the volume of the first glass ceramic compound is too large, the sintering temperature of the solid electrolyte may increase, and there may be an issue of reduced ionic conductivity due to non-sintering. If the volume of the second glass ceramic compound is too large, there may be an issue of decreased ionic conductivity of the solid electrolyte.

Additionally, the second glass ceramic compound may have lower electronic conductivity than the first glass ceramic compound. Accordingly, there may be an advantage in reducing the growth of lithium dendrites, which are generated by combining electrons and lithium ions inside the solid electrolyte, by lowering the electron movement efficiency at the grain boundary of the solid electrolyte.

More specifically, the first glass ceramic compound may have a lithium ion conductivity of 1.0×10⁻⁵ S/cm or more at 25° C., and more specifically, 1.0×10⁻⁵ S/cm to 4.0×10⁻⁴ S/cm.

In addition, the second glass ceramic compound may have a lithium ion conductivity of 1.0×10⁻⁵ S/cm or less at 25° C., and more specifically, 1.0×10⁻⁵ S/cm to 1.0×10⁻⁵ S/cm.

In addition, the first glass ceramic compound may have an electronic conductivity of 2.0×10⁻¹⁰ S/cm or more at 25° C., and more specifically, 2.0×10⁻⁵ S/cm to 5.0×10⁻¹⁰ S/cm.

The second glass ceramic compound may have an electronic conductivity of 2.0×10⁻¹⁰ S/cm or less at 25° C., and more specifically, 1.0×10⁻¹⁰ S/cm to 2.0×10⁻¹⁰ S/cm.

### 2. All-Solid-State Battery

Another embodiment of the present disclosure provides an all-solid-state battery, including a positive electrode layer, a negative electrode layer, and a solid electrolyte layer positioned between the positive electrode layer and the negative electrode layer, wherein the solid electrolyte layer includes the solid electrolyte described above.

More specifically, the positive electrode layer may include a positive electrode current collector and a positive electrode active material layer disposed on the positive electrode current collector.

For example, the positive electrode active material layer may include a positive electrode active material and a solid electrolyte. The solid electrolyte included in the positive electrode active material layer may be the same as or different from the solid electrolyte included in the solid electrolyte sheet.

The positive electrode active material is a material that may reversibly insert and de-insert lithium ions. The positive electrode active material may include, for example, lithium transition metal oxides such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, nickel sulfide, copper sulfide, lithium sulfide, iron oxide, vanadium oxide, or the like, but is not necessarily limited thereto. Any material available as a positive electrode active material in the art may be used. The positive electrode active material may be used alone or in a mixture of two or more thereof.

The lithium transition metal oxide may include, for example, LiₐA_{1-b}B_{b}D₂ (where 0.90≤a≤1, and 0≤b≤0.5); LiₐE_{1-b}B_{b}O_{2-c}D_{c} (where 0.90≤a≤1, 0.5 b s 0.5, 0≤5≤c≤0.05); LiE_{2-b}B_{b}O_{4-c}D_{c} (where 0≤b≤0.5, 0≤c≤0.05); LiₐNi_{1-b-c} Co_{b}B_{c}Dₐ (where 0.90≤a≤1, 0≤b≤0.5, 0≤c≤0.05, 0≤a s 2); LiₐNi_{1-b-c} Co_{b}B_{c}O₂₋ₐFₐ (where 0.90≤a≤1, 0≤b≤0.5, 0≤c≤0.05, 0≤a≤2); LiₐNi_{1-b-c} Co_{b}B_{c}O₂₋ₐF₂ (where 0.90≤a≤1, 0≤b≤0.5, 0≤c≤0.05, 0≤a≤2); LiₐNi_{1-b-c}Mn_{b}B_{c}Dₐ (where 0.90≤a≤1, 0≤b≤0.5, 0≤c≤0.05, 0≤a≤2); LiₐNi_{1-b-c}Mn_{b}B_{c}O₂₋ₐFₐ (where 0.90≤a≤1, 0≤b≤0.5, 0≤c≤0.05, 0≤a≤2); LiₐNi_{1-b-c}Mn_{b}B_{c}O₂₋ₐF₂ (where 0.90≤a≤1, 0≤b≤0.5, 0≤c≤0.05, 0≤a≤2); LiₐNi_{b}E_{c}G_{d}O₂(where 0.90≤a≤1,0≤b≤0.9, 0≤c≤0.5, 0.001≤d≤0.1); LiₐNi_{b} Co_{c}Mn_{d}GₑO₂ (where 0.90 s a s 1,0≤b≤0.9, 0≤c≤0.5, 0≤d≤0.5, 0.001≤e≤0.1); LiₐNiG_{b}O₂(where 0.90≤a≤1, 0.001≤b≤0.1); Liₐ CoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); a compound represented by any one of chemical formulas of QO₂; QS₂; LiQS₂; V₂O₅; LiV₂O₅; LilO₂; LiNiVO₄; Li_{(3-f)}J₂ (PO₄)₃ (0≤f≤2); Li_{(3-f)}Fe₂ (PO₄)₃ (0≤f≤2); LiFePO₄. In these compounds, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof. A compound to which a coating layer is added to a surface thereof, or a mixture of the compound described above and a compound to which a coating layer is added may be used. The coating layer added to the surface of such a compound may include, for example, a compound of an oxide of a coating element, a hydroxide of a coating element, an oxyhydroxide of a coating element, an oxycarbonate of a coating element, or a hydroxycarbonate of a coating element. The compound constituting the coating layer may be amorphous or crystalline. The coating element included in the coating layer may include Mg, Al, Co, K, Na, Ca, Si, Ti, V, Sn, Ge, Ga, B, As, Zr, or a mixture thereof. A method of forming a coating layer may be a suitable method that does not adversely affect the physical properties of the positive electrode active material. A coating method may include, for example, spray coating, dipping, or the like. Since the specific coating method is well understood by those working in the field, detailed explanation will be omitted.

The positive electrode active material layer may include, for example, a solid electrolyte. The solid electrolyte included in the positive electrode layer may be the same as or different from the solid electrolyte included in the solid electrolyte layer.

The positive electrode active material layer may include, for example, a binder. The binder may include, for example, styrene butadiene rubber (SBR), polytetrafluoroethylene, polyvinylidene fluoride, polyethylene, or the like, but is not necessarily limited thereto. Any material available as a binder in the art may be used.

The positive electrode active material layer may include, for example, a conductive material. The conductive material may include, for example, graphite, carbon black, acetylene black, Ketjen black, carbon fiber, metal powder, or the like, but is not limited thereto. Any material available as a conductive material in the art may be used.

For example, the positive electrode active material layer may further include additives such as a filler, a coating agent, a dispersant, an ion conductivity auxiliary agent, or the like, in addition to the positive electrode active material described above, the solid electrolyte, the binder, and the conductive material.

As a filler, a coating agent, a dispersant, an ion conductive auxiliary agent, or the like, that the positive electrode active material layer may include, known materials generally used for an electrode of an all-solid-state secondary battery may be used.

As a positive electrode current collector, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or a plate of foil made of an alloy thereof may be used. The thickness of the positive electrode current collector may be, for example, 1 μm to 100 μm, 1 μm to 50 μm, 5 μm to 25 μm, or 10 μm to 20 μm.

More specifically, the negative electrode layer may include a negative electrode current collector and a negative electrode active material layer disposed on the negative electrode current collector.

The negative electrode active material layer may include, for example, a negative electrode active material and a binder.

The negative electrode active material may include, for example, a carbon-based negative electrode active material, a metallic/metalloid negative electrode active material, or a combination thereof.

The carbon-based negative electrode active material may be amorphous carbon. The amorphous carbon may include, for example, carbon black (CB), acetylene black (AB), furnace black (FB), ketjen black (KB), graphene, or the like, but is not necessarily limited thereto. Any material categorized as amorphous carbon in the art may be used. The amorphous carbon is carbon that has no or very low crystallinity, and in this regard, may be distinguished from crystalline carbon or graphite-based carbon.

The metallic/metalloid negative electrode active material may include at least one selected from lithium (Li), gold (Au), platinum (Pt), palladium (Pd), silicon (Si), silver (Ag), aluminum (AI), bismuth (Bi), tin (Sn), and zinc (Zn), but is not necessarily limited thereto. Any material available as a metallic negative electrode active material or metalloid negative electrode active material capable of forming an alloy or compound with lithium in the art may be used.

The binder included in the negative electrode active material layer may include, for example, styrene-butadiene rubber (SBR), polytetrafluoroethylene, polyvinylidene fluoride, polyethylene, vinylidene fluoride/hexafluoropropylene copolymer, polyacrylonitrile, polymethyl methacrylate, or the like, but is not necessarily limited thereto. Any material available as a binder in the art may be used. The binder may be used alone, or may be used with multiple binders that are different from each other.

When the negative electrode active material layer includes the binder, the negative electrode active material layer may be stabilized on the negative electrode current collector. In addition, despite a change in volume and/or relative position of the negative electrode active material layer during charging and discharging, cracking of the negative electrode active material layer may be suppressed.

The negative electrode active material layer may further include additives, for example, a filler, a coating agent, a dispersant, an ion conductive auxiliary agent, or the like, as used in the conventional all-solid-state battery.

The negative electrode active material layer may further include, for example, a solid electrolyte. At this time, the solid electrolyte included in the negative electrode layer may be the same as or different from the solid electrolyte included in the solid electrolyte layer.

The all-solid-state battery may further include a second negative electrode active material layer disposed between the negative electrode current collector and the negative electrode active material layer during charging. The second negative electrode active material layer may be precipitated between the negative electrode current collector and the negative electrode current collector during the charging, or may be further disposed on the negative electrode active material layer during electrode assembly. This second negative electrode active material layer may be a metal layer including lithium or a lithium alloy. The lithium alloy may include, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, but is not limited thereto. Any material available as a lithium alloy in the art may be used. The second negative electrode active material layer may consist of one of these alloys and/or lithium, or may consist of several types of alloy and/or lithium.

The negative electrode current collector may be formed of, for example, a material that does not react with lithium, that is, a material that forms neither an alloy nor a compound with lithium. The negative electrode current collector may include, for example, copper (Cu), stainless steel, titanium (Ti), iron (Fe), cobalt (Co), nickel (Ni), and the like, but is not limited thereto. Any material available as an electrode current collector in the art may be used. The negative electrode current collector may be formed of one of the above-described metals, an alloy of two or more of the above-described metals, or a coating material. The negative electrode current collector may be, for example, in the form of a plate or foil.

Hereinafter, embodiments of the present disclosure will be described in more detail through examples. However, the following example is only a preferred example of the present disclosure, and the present disclosure is not limited to the following example.

### Preparation Example 1 (First Glass Ceramic Compound A)

As raw materials, Ti(OC₃H₁₂)₄, LiNO₃, AI(NO₃)₃, and NH₄H₂PO₄ were added and mixed according to the target stoichiometric ratio, and then fired at a temperature of 1300° C. to prepare a compound with the NASICON structure, represented by LiTi₂Al(PO₄)₃.

### Preparation Example 2 (First Glass Ceramic Compound B)

As raw materials, Li₂CO₃, La₂O₃, and Zr(OC₂H₅)₄ were added and mixed according to the target stoichiometric ratio, and then fired at a temperature of 1300° C. to prepare a compound with a garnet structure compound represented by Li₇La₃Zr₂O₁₂.

### Preparation Example 3 (First Glass Ceramic Compound C)

As raw materials, Li₂CO₃, La₂O₃, Zr(OC₂H₅)₄, and Ga₂O₃ were added and mixed according to the target stoichiometric ratio, and then fired at a temperature of 1300° C. to prepare a compound with a garnet structure represented by Li_{6.4}Ga_{0.2}La₃Zr₂O₁₂.

Preparation Example 4 (first glass ceramic compound D) As raw materials, Li₂CO₃, La₂O₃, Zr(OC₂H₅)₄, and Al₂O₃were added and mixed according to the target stoichiometric ratio, and then fired at a temperature of 1300° C. to prepare a compound with a garnet structure represented by Li_{6.4}Al_{0.2}La₃Zr₂O₁₂.

Preparation Example 5 (second glass ceramic compound E) As raw materials, Li₂CO₃, B₂O₃, Al₂O₃, Ga₂O₃, and LiCl were added and mixed according to the target stoichiometric ratio, and then fired at a temperature of 1300° C. to prepare a compound represented by Li₄B₄Ga₃O₁₂Cl.

Preparation Example 6 (second glass ceramic compound F) After adding and mixing Li₂CO₃, B₂₀₃, Al₂O₃, ZnO, and LiCl as raw materials according to the target stoichiometric ratio, a compound represented by Li₄B₄Zn₃O₁₂Cl was prepared at a temperature of 1300° C.

Preparation Example 7 (second glass ceramic compound G) After adding and mixing Li₂CO₃, B₂₀₃, Al₂O₃, MgO, and LiCl as raw materials according to the target stoichiometric ratio, a compound represented by Li₄B₄Mg₃O₁₂Cl was prepared at a temperature of 1300° C.

Preparation Example 8 (second glass ceramic compound H) After adding and mixing Li₂CO₃, B₂O₃, Al₂O₃, MgO, Ga₂O₃, and LiCl as raw materials according to the target stoichiometric ratio, a compound represented by Li₄B₄Mg₂GaO₁₂Cl was prepared at a temperature of 1300° C.

Preparation Example 9 (second glass ceramic compound I) After adding and mixing Li₂CO₃, B₂O₃, Al₂O₃, Al₂O₃, and LiCl as raw materials according to the target stoichiometric ratio, a compound represented by Li₄B₄Al₃O₁₂Cl was prepared at a temperature of 1300° C.

### Example 1

### (1) Solid Electrolyte Preparation

A solid electrolyte layer was prepared by mixing the first glass ceramic compound B, which is prepared by Preparation Example 2 having an average particle diameter (D50) of 10 μm, and the second glass ceramic compound I, which is prepared by Preparation Example 9 having an average particle diameter (D50) of 5 μm, in 51% by volume and 49% by volume respectively, mixing and drying the total solid electrolyte compound: binder (polymethacrylate): solvent (dihydroterpineol) at a weight ratio of 100:10:150, and then sintering the mixture at a sintering temperature of 500° C. for 10 minutes.

### (2) All-Solid-State Battery Manufacturing

An all-solid-state battery was manufactured by applying the solid electrolyte layer, a positive electrode layer with a lithium cobalt oxide positive electrode active material layer, and a negative electrode layer with a graphite negative electrode active material layer.

### Example 2 to 10

A solid electrolyte and an all-solid-state battery were manufactured in the same manner as in Example 1, except that the types of the first and second glass ceramic compounds composited as a solid electrolyte were different as shown in Table 2 below.

### Comparative Example 1

An all-solid-state battery was manufactured in the same manner as in Example 1, except that the second glass ceramic compound I prepared in Preparation Example 9 was used alone as a solid electrolyte.

### Comparative Example 2 to 5

An all-solid-state battery was manufactured in the same manner as in Comparative Example 1, except that the type of the second glass ceramic compound used alone as the solid electrolyte was different as shown in Table 2 below.

### Experimental Example 1: Evaluation of Solid Electrolyte Ionic Conductivity and Electronic Conductivity of Preparation Example

The lithium ion conductivity, electronic conductivity, and sintering temperature of each solid electrolyte prepared in Preparation Examples 1 to 9 were evaluated, and these are shown in Table 1 below.

TABLE 1

| | | | | Lithium ion | Electron | Sintering |
|---|---|---|---|---|---|---|
| | | | | conductivity | conductivity | temperature |
| | Type | Compound | Specific composition | (S/cm) | (S/cm) | (° C.) |
| Preparation | First | A | LiTi₂Al PO₄₃ | 5.21 × 10⁻⁵ | 5.40 × 10⁻⁷ | 1300 |
| Example 1 | glass | | | | | |
| Preparation | ceramic | B | Li₇La₃Zr₂O₁₂ | 3.54 × 10⁻⁵ | 7.82 × 10⁻⁷ | 1300 |
| Example 2 | compound | | | | | |
| Preparation | | C | Li_{6.4}Ga_{0.2}La₃Zr₂O₁₂ | 2.44 × 10⁻⁴ | 6.22 × 10⁻⁶ | 1300 |
| Example 3 | | | | | | |
| Preparation | | D | Li_{6.4}Al_{0.2}La₃Zr₂O₁₂ | 3.62 × 10⁻⁴ | 4.89 × 10⁻⁶ | 1300 |
| Example 4 | | | | | | |
| Preparation | Second | E | Li₄B₄Ga₃O₁₂Cl | 2.44 × 10⁻⁶ | 1.24 × 10⁻¹⁰ | 500 |
| Example 5 | glass | | | | | |
| Preparation | ceramic | F | Li₄B₄Zn₃O₁₂Cl | 1.24 × 10⁻⁶ | 2.44 × 10⁻¹⁰ | 500 |
| Example 6 | compound | | | | | |
| Preparation | | G | Li₄B₄Mg₃O₁₂Cl | 3.01 × 10⁻⁶ | 2.54 × 10⁻¹⁰ | 500 |
| Example 7 | | | | | | |
| Preparation | | H | Li₄B₄Mg₂GaO₁₂Cl | 4.14 × 10⁻⁷ | 3.24 × 10⁻¹⁰ | 500 |
| Example 8 | | | | | | |
| Preparation | | I | Li₄B₄Al₃O₁₂Cl | 5.24 × 10⁻⁷ | 4.22 × 10⁻¹⁰ | 500 |
| Example 9 | | | | | | |

### Experimental Example 2: Solid Electrolyte SEM Image Evaluation

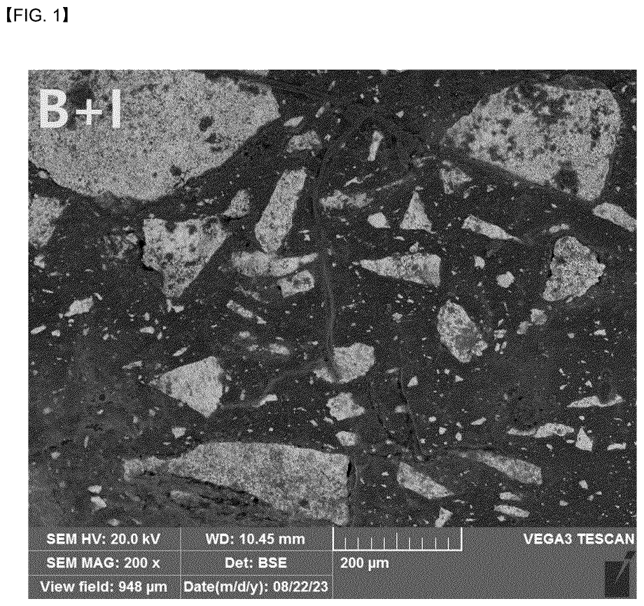

The scanning electron microscope (SEM) image of the solid electrolyte prepared according to Example 1 was evaluated and is shown in FIG. 1.

Referring to FIG. 1, it can be seen that the composite solid electrolyte based on the mixed sintered body of Example 1 had excellent sintering properties and that crystalline glass with excellent ionic conductivity was evenly distributed. In addition, since the two types of combined solid electrolytes had different physical and chemical properties, it can be seen that the two types of solid electrolytes were easily distinguished in the SEM image.

### Experimental Example 3: Evaluation of Solid Electrolyte Sintering Temperature and all-Solid-State Battery Capacity Characteristics

The sintering temperature of the solid electrolyte manufactured according to the Examples and Comparative Examples was evaluated, and the initial capacity characteristics of the all-solid-state battery manufactured according to the Examples and Comparative Examples were evaluated, which are shown in Table 2 below. For initial capacity characteristics, cells were manufactured, aged at 25° C. for 12 hours, and then charging and discharging test was conducted at 25° C. To evaluate the initial capacity, 200 mAh/g was used as the reference capacity, and the battery were charged to 4.25 V at a constant current of 0.10 C, then switched to constant voltage and charged until the termination current reached 0.05 C. After charging, the battery was allowed to rest for 10 minutes and then discharged at a constant current of 0.10 C with a reference capacity of 200 mAh/g until it reached 2.5 V.

TABLE 2

| | | Mixed | | | | |
|---|---|---|---|---|---|---|
| | | volume | | | | |
| | | ratio | | | | |
| | | (first:second | | Initial | Initial | Non- |
| | Composite | glass | Sintering | charge | discharge | reversible |
| | solid | ceramic | temperature | capacity | capacity | capacity |
| | electrolyte | compound) | (° C.) | (mAh/g) | (mAh/g) | (mAh/g) |
| Example 1 | B + I | 51:49 | 500 | 135 | 129 | 6 |
| Example 2 | B + H | 51:49 | 500 | 121 | 114 | 7 |
| Example 3 | B + G | 51:49 | 500 | 115 | 102 | 13 |
| Example 4 | B + F | 51:49 | 500 | 106 | 98 | 8 |
| Example 5 | B + E | 51:49 | 500 | 117 | 94 | 23 |
| Example 6 | A + I | 51:49 | 500 | 112 | 85 | 27 |
| Example 7 | A + H | 51:49 | 500 | 130 | 97 | 33 |
| Example 8 | A + G | 51:49 | 500 | 124 | 86 | 38 |
| Example 9 | A + F | 51:49 | 500 | 119 | 89 | 30 |
| Example 10 | A + E | 51:49 | 500 | 126 | 99 | 27 |
| Comparative | I | — | Same as | 103 | 73 | 30 |
| Example 1 | | | Table 1 | | | |
| Comparative | H | — | Same as | 98 | 68 | 30 |
| Example 2 | | | Table 1 | | | |
| Comparative | G | — | Same as | 88 | 53 | 35 |
| Example 3 | | | Table 1 | | | |
| Comparative | F | — | Same as | 86 | 63 | 23 |
| Example 4 | | | Table 1 | | | |
| Comparative | E | — | Same as | 76 | 50 | 26 |
| Example 5 | | | Table 1 | | | |

Referring to Table 2, in the case of Examples 1 to 10 in which the first glass ceramic compound and the second glass ceramic compound were combined, it can be seen that the initial charge capacity and initial discharge capacity were improved compared to Comparative Example 1 using only the second glass ceramic compound. Through this, it can be seen that the ionic conductivity of the composite solid electrolyte was improved compared to the solid electrolyte alone.

In addition, it can be seen that the sintering temperature of the composite solid electrolytes of Examples 1 to 10 was significantly lower than that of the first glass ceramic compound alone.

Through this, it can be seen that the solid electrolyte according to the present disclosure has excellent ionic conductivity and lowers the sintering temperature as the first glass ceramic compound and the second glass ceramic compound are combined.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

Therefore, the actual scope of the present disclosure will be defined by the appended claims and their equivalents.

1. A solid electrolyte, that is a composite comprising a first glass ceramic compound and a second glass ceramic compound.

2. The solid electrolyte of claim 1, wherein
the first glass ceramic compound includes a Na super-ionic conductor (NASICON) structure compound or a garnet structure compound.

3. The solid electrolyte of claim 2, wherein
the Na super-ionic conductor structure compound is represented by the following Chemical Formula 1:
Liₐ₁M1_{b1}Al_{c1}(PO₄)_{d1} [Chemical Formula 1]
in Chemical Formula 1, M1 is a doping element and is Ti, Ga, or a combination thereof, 1≤a1≤1.5, 0.1≤b1≤2.5, 0≤c1≤1.5, and 3.5≤d1≤4.5.

4. The solid electrolyte of claim 2, wherein
the garnet structure compound is represented by the following Chemical Formula 2:
Liₐ₂La_{b2}Zr_{c2}M2_{d2}Oₑ₂ [Chemical Formula 2]
in Chemical Formula 2, M2 is a doping element and is Ga, Al, Rb, Ti or a combination thereof, 5.5≤a2≤7.5, 2.5≤b2≤3.5, 1.5≤c2≤2.5, 0≤d2≤1, and 11.5≤e2≤12.5.

5. The solid electrolyte of claim 1, wherein
the second glass ceramic compound comprises Li, B, O, and halogen elements, and further comprises at least one of Ga, Zn, Mg, Al, Ge, Si, Ti, P, and Bi.

6. The solid electrolyte of claim 1, wherein
the second glass ceramic compound is represented by the following Chemical Formula 3:
Liₐ₃B_{b3}O_{c3}D_{d3}M3ₑ₃ [Chemical Formula 3]
in Chemical Formula 3, D is a halogen element and is F, Cl, Br, I or a combination thereof, M3 is Ga, Zn, Mg, Al, Ge, Si, Ti, P, Bi or a combination thereof, 3≤a3≤4, 3.5≤b3≤5.5, 11.5≤c3≤12.5, 0≤d3:1, and 1.5≤e3≤3.5.

7. The solid electrolyte of claim 1, wherein
the first glass ceramic compound occupies 51% by volume or more based on the total volume of the solid electrolyte.

8. The solid electrolyte of claim 1, wherein
the second glass ceramic compound occupies 49% by volume or less based on the total volume of the solid electrolyte.

9. The solid electrolyte of claim 1, wherein
the first glass ceramic compound has a higher lithium ion conductivity than the second glass ceramic compound.

10. The solid electrolyte of claim 1, wherein
the second glass ceramic compound has lower electronic conductivity than the first glass ceramic compound.

11. The solid electrolyte of claim 1, wherein
the first glass ceramic compound has a lithium ion conductivity of 1.0×10⁻⁵ S/cm or more at 25° C.

12. The solid electrolyte of claim 1, wherein
the second glass ceramic compound has a lithium ion conductivity of 1.0×10⁻⁵ S/cm or less at 25° C.

13. The solid electrolyte of claim 1, wherein
the first glass ceramic compound has an electronic conductivity of 2.0×10⁻¹⁰ S/cm or more at 25° C.

14. The solid electrolyte of claim 1, wherein
the second glass ceramic compound has an electronic conductivity of 2.0×10⁻¹⁰ S/cm or less at 25° C.

15. The solid electrolyte of claim 1, wherein the first glass ceramic compound and the second glass ceramic compound include an amorphous phase and one or more crystalline phases.

16. The solid electrolyte of claim 1, wherein
the first glass ceramic compound occupies a greater volume percentage than the second glass ceramic compound based on the total volume of the solid electrolyte.

17. An all-solid-state battery, comprising:
a positive electrode layer; a negative electrode layer; and a solid electrolyte layer positioned between the positive electrode layer and the negative electrode layer, wherein the solid electrolyte layer comprises the solid electrolyte of claim 1.

18. The all-solid-state battery of claim 17, wherein
the positive electrode layer comprises a current collector and a positive electrode active material layer positioned on the current collector, and the negative electrode layer comprises a current collector and a negative electrode active material layer positioned on the current collector, and
the positive electrode active material layer or the negative electrode active material layer comprises the solid electrolyte of claim 1.
